(19) United States
(12) Patent Application Publication
(10) Pub. No.: US 2017/0068279 A1
(43) Pub. Date: Mar. 9, 2017

(54) PRODUCT ASSEMBLY FEATURES OF A PORTABLE ELECTRONIC DEVICE

(71) Applicant: Apple Inc., Cupertino, CA (US)

(72) Inventors: Daniel W. JARVIS, Sunnyvale, CA (US); James B. SMITH, Los Gatos, CA (US); Kuldeep P. LONKAR, Cupertino, CA (US); Timothy S. LUI, Cupertino, CA (US); Robert F. MEYER, Cupertino, CA (US); Michael W. FIRKA, Cupertino, CA (US); Lee E. HOOTON, Cupertino, CA (US); Thomas R. LUCE, Cupertino, CA (US)

(21) Appl. No.: 15/258,895

(22) Filed: Sep. 7, 2016

Related U.S. Application Data
(60) Provisional application No. 62/215,559, filed on Sep. 8, 2015.

(51) Int. Cl. G06F 1/16; H04B 1/3888; H04M 1/02

(52) U.S. Cl. CPC G06F 1/1658; H04M 1/0252; H04M 1/0277; H04B 1/3888; G06F 2200/1634; G06F 2200/1631

(57) ABSTRACT

This application relates to a portable electronic device includes at least a device housing having walls that define a cavity, the walls having edges that define an opening that leads into the cavity. Component assembly features used to secure components received through the opening to each other and/or to the walls during an assembly operation, and a protective cover formed of transparent material and disposed within the opening and secured to the housing.

### CROSS-REFERENCE TO RELATED APPLICATIONS

This application claims the benefit of priority under 35 U.S.C §119(e) to U.S. Provisional Application No. 62/215,559, entitled “PRODUCT ASSEMBLY FEATURES OF A PORTABLE ELECTRONIC DEVICE,” filed on Sep. 8, 2015, which is incorporated by reference herein in its entirety.

### FIELD

The described embodiments relate generally to a portable electronic device and more specifically, product assembly features and methods for assembly thereof.

### BACKGROUND

Portable electronic devices can present a challenging assembly due to their compact size and densely packed components.

### SUMMARY

Other aspects and advantages of the invention will become apparent from the following detailed description taken in conjunction with the accompanying drawings which illustrate, by way of example, the principles of the described embodiments.

A portable electronic device includes at least a device housing having walls that define a cavity, the walls having edges that define an opening that leads into the cavity. Component assembly features are used to secure components received through the opening to each other and/or to the walls during an assembly operation. The portable electronic device also includes a protective cover formed of transparent material and that is disposed within the opening and secured to the housing.

In one embodiment, a curved contact spring for bridging a gap between two separate parts of an electrical assembly. The curved contact spring includes a solid sheet of conductive material having a curved geometry and having a fixed end affixed to a first side of the gap and wherein the curved geometry causes a free end the solid sheet of conductive material to curve towards and to contact a second side of the gap.

A retention strap capable of retaining a circuit module, the retention strap includes a body having a size and shape corresponding to the circuit module and a fastener arranged to secure the body to a printed circuit board, wherein the body maintains a relative position of the circuit module with respect to an other component mounted to the printed circuit board.

In one embodiment, a method is carried out by placing a mid-plate shim on a display component, pressing the mid-plate onto the mid-plate shim, and removing the mid-plate shims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an exemplary device 10 suitable for use with the described embodiments;

FIGS. 2A-2B shows flexible circuit arrangement in accordance with the described embodiments;

FIGS. 3A-3C show representative embodiments of insert molded C-Clip assembly;

FIGS. 4A-4D show representative examples of curved grounding springs and uses thereof;

FIG. 5 shows a retaining feature in accordance with the described embodiments;

FIGS. 6A-6B show representative micro-fasteners and their use in accordance with the described embodiments;

FIGS. 7A-7C show integrated snap feature system in accordance with an embodiment; and

FIG. 8 is a block diagram of an electronic device suitable for controlling some of the processes in the described embodiment.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

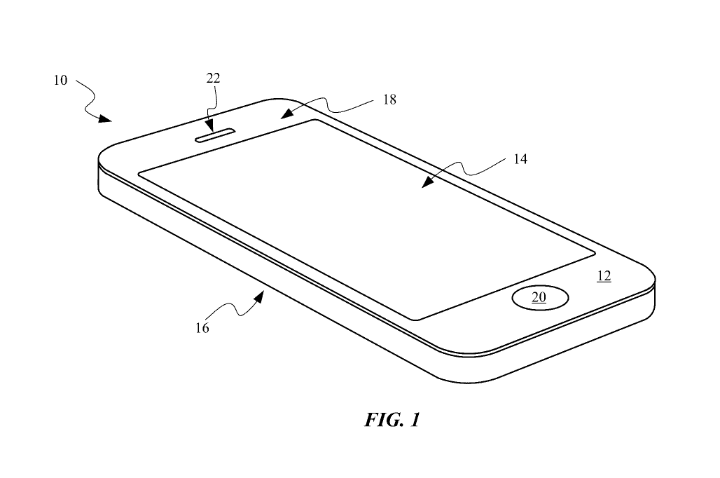

These and other embodiments are discussed below with reference to FIGS. 1-8; however, those skilled in the art will readily appreciate that the detailed description given herein with respect to these figures is for explanatory purposes only and should not be construed as limiting.

FIG. 1 shows an exemplary device 10 suitable for use with the described embodiments. As depicted a display cover 12 defines a substantial portion of a top surface of device 10. Display cover 12 can also be referred to as cover-glass and can be formed of a durable transparent material along the lines of glass or plastic. Display cover 12 provides a cosmetically and tactilely pleasing surface upon which user inputs can be received. Display cover 12 can overlay display assembly 14, which is contained within and protected by display cover 12 and housing component 16. In some embodiments display assembly 14 can be a touch sensitive display assembly. The touch sensors driving the touch sensitivity can be positioned in many locations. In some embodiments, the touch sensor can be integrated into display assembly 14 and in other embodiments at least a portion of the touch sensor can be applied to an interior facing surface of display cover 12. In some embodiments, masked regions 18 of display cover 12 can be masked by, for example, an amount of ink selectively positioned upon the interior facing surface of display cover 12. The ink can be applied to display cover 12 in a manner so that the only transparent portion of display cover 12 is that portion that overlays an active display portion of display assembly 14. Various colors of ink can be used. Display cover 12 can also define a number of openings. For example, one opening can be configured to allow a user access to button 20. Another opening 22 can be configured to allow audio content generated by a speaker component within housing component 16 to leave device 10 while device 10 is being used as a phone.

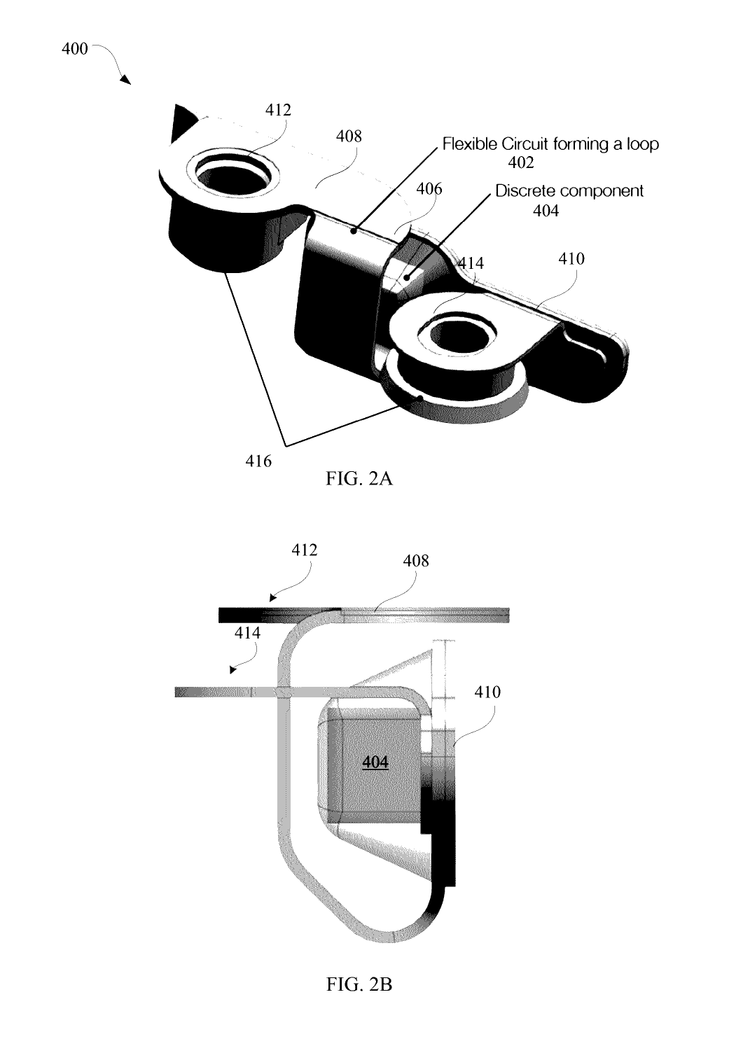

FIG. 2A shows flexible circuit arrangement 400 in accordance with the described embodiments. Flexible circuit arrangement 400 can include flexible circuit 402 electrically coupled to discrete component 404 at a connector portion 406. Flexible circuit 402 can have wings 408 and 410 that extend out from connector portion 406 forming in essence a spiral ribbon. Flexible circuit 402 can, in turn, be secured by way of securing holes 412 and 414 to mounting points 416. Accordingly, the spiral shape of flexible connector 402 can enable flexible connector 402 to stretch or compress when mounting points 416 move with respect to each other without incurring any damage. FIG. 2B shows a cross sectional view of flexible circuit arrangement 400 highlighting the spiral shape of wings 408 and 410.

Clip Insert Molded into Plastic

This invention relates to creating a structure where a metal part is insert molded on a plastic part where surfaces of the metal on opposite sides of the plastic part are exposed. In an electronic device, an electrically conductive path with exposed contact surfaces between opposite sides of a plastic part is often needed. Typically, a machined metal insert is molded into the plastic or a separate C-clip is assembled to the plastic part after molding. In the case of the machined insert molded part, both sides cannot be flush to the plastic surface due to potential plastic overflow during the molding process caused by part and tool tolerances.

In the primary embodiment of this invention, both sides of the metal insert are exposed and flush to the plastic surface. A sheet metal C-clip is insert molded into the plastic. In order to prevent plastic flash and overflow, the C-clip is designed to have mold tooling pins press outwards on both sides and to have a somewhat flexible section between the opposite surfaces to allow the part to move when the opposite sides are pressed outward.

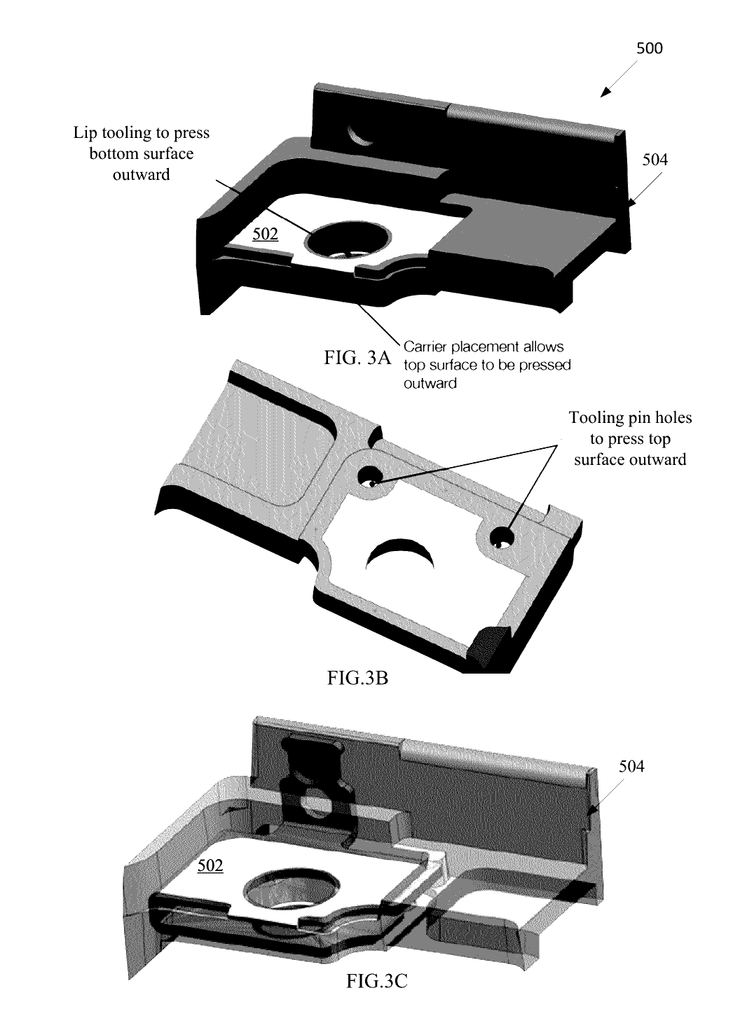

FIGS. 3A-3C show representative embodiments of insert molded C-clip assembly 500. More specifically, FIG. 3A shows metal C-clip assembly 500 having metal C-clip 502 and mounted to plastic part 504. This invention relates to grounding two plates separated by a narrow and variable air gap inside of an electronic device.

### Spring for Electrically Connecting Two Surfaces Across a Variable Gap

Often, separate parts within an electrical system must be grounded together to meet EMI performance goals and is typically done by using contact springs, conductive foams, and other conductive filler material. In the case where the minimum expected gap is very narrow, conventional spring and foam solutions will not fit within the smallest expected gap—the required minimum gap is usually determined by the formed spring geometries or the thickness of the fully compressed foam.

In the primary embodiment of this invention, the very narrow and variable air gap is bridged by a gently curved solid sheet of conductive material (sheet metal) affixed to one side of the gap by one side of the sheet. The free end of the sheet is curved toward the other side of the gap and contacts it. The curve is a very gradual—it is either a large radius or a gentle spline profile so that the spring is able to lay flat without yielding when fully compressed. Grounding two surfaces in this manner allows a significantly narrower minimum gap between the two plates as the minimum required gap is only the material thickness of the sheet. The thickness of the sheet is normally less than half the thickness of a conventional approach. Moreover, minimizing gaps between parts is paramount in miniaturizing electronic devices.

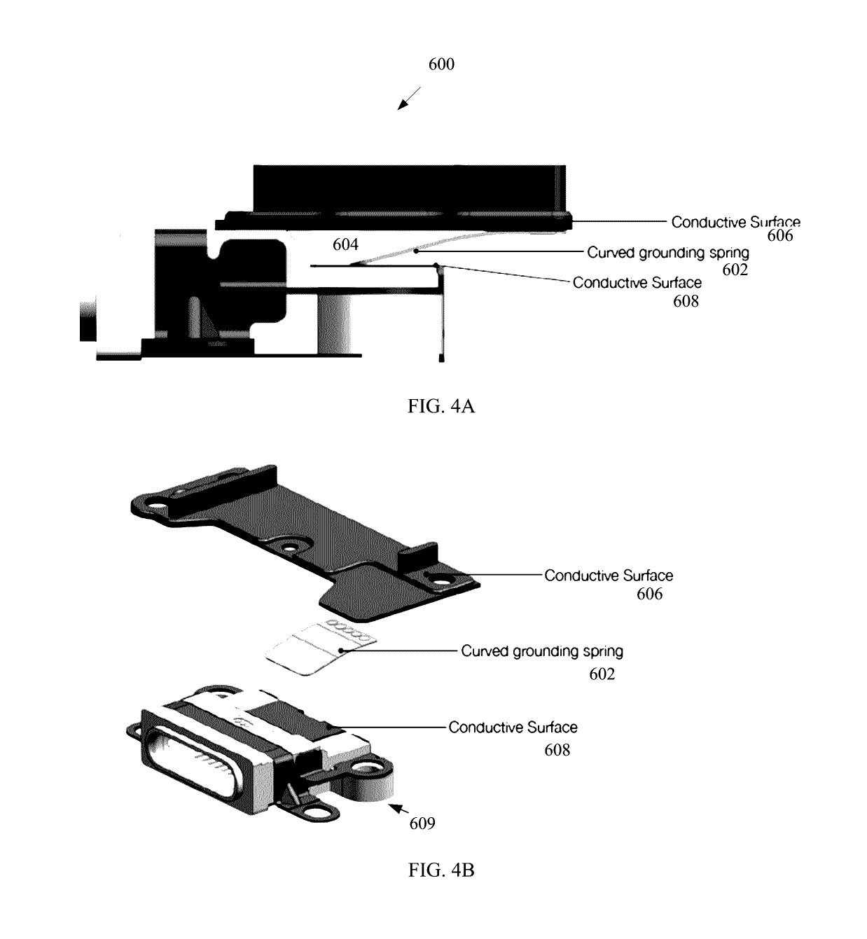

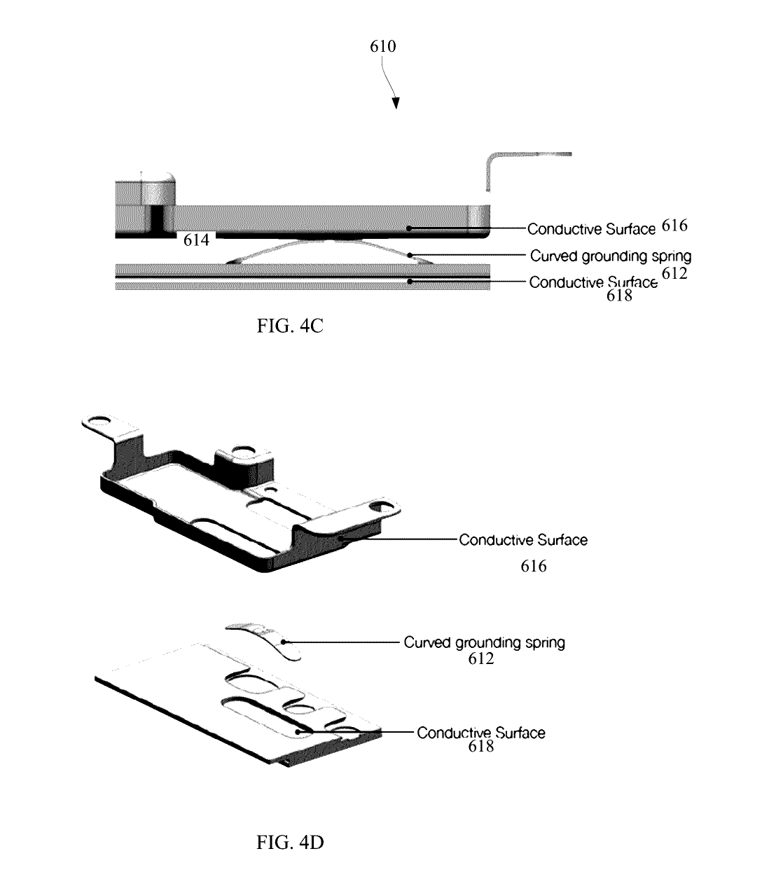

FIGS. 4A-4D show representative examples of the described embodiments. FIGS. 4A-4B illustrate arrangement 600 showing curved grounding spring 602 providing conductive path across narrow gap 604 separating conductive surface 606 and conductive surface 608. For example, conductive surface 606 can be associated with a flex connector whereas conductive surface 608 can be associated with an electrical connector such as connector 609. FIGS. 4C-4D illustrate arrangement 610 showing curved grounding spring 612 providing conductive path across narrow gap 614 separating conductive surfaces 616 and 618.

### Retention Features

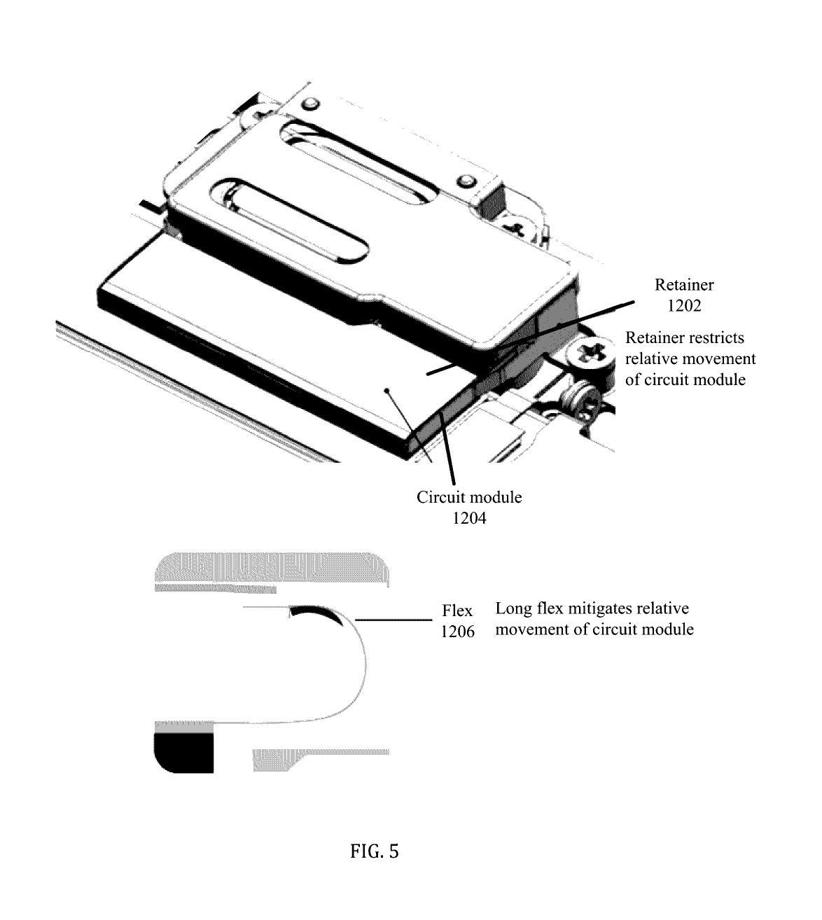

The embodiments herein describe a securing feature. In particular, the securing feature can take the form of a retention strap capable of retaining an electronic component. In a particular embodiment, the electronic component can take the form of a circuit module. The retention strap can be used to decouple a flex connector that couples the circuit module to another electronic component. In this way, any relative movement between the circuit module and the other electronic component will not affect the electrical properties of the connection between the flex connector and the circuit module and other component. As shown in FIG. 5, showing system 1200 where retainer 1202 secures circuit module 1204 in such a way that movement of circuit module 1204 during, for example, a drop event, is prevented for the most part. Moreover, extended flex 1206 can be used to electrically couple circuit module 1204 to another component 1208 and due to the extended length can mitigate any potential connection issues due to relative movement between circuit module 1204 and the other component 1208.

Micro-Fastener with Self Aligning Feature

Historically, installing micro-fasteners is complicated by their small size, diameter, and very fine thread pitch, which can contribute to cross-threading and mis-alignment problems during installation. These issues are compounded when the fasteners are installed with poor driver clearance with a small enclosure, or when the fastener must be driven in a non-axial manner.

Accordingly, the following describes a fastener having a self-aligning section at the tip, preceding the threaded portion, that facilitates alignment and reduces cross threading. Accordingly, in one embodiment, the fastener is formed to have a tightly controlled diameter that interfaces closely with the threads of the mating part causing the fastener to align to the hole before the threads engage. The length of the close-fit portion is sized to maximize the number of mating threads engaged without causing interference with the bottom of the tapered hole. Accordingly, the fastener is much easier to use especially in situations when the driver cannot be operating in an axial manner.

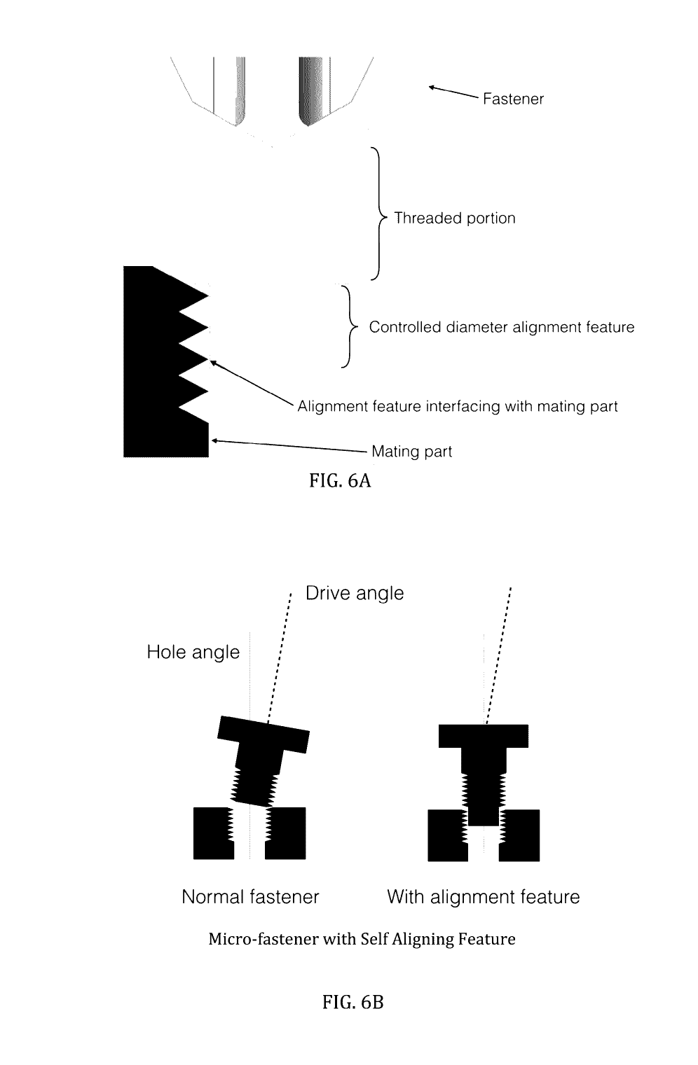

Accordingly, FIGS. 6A-6B show representative micro-fasteners 1300 and their use in accordance with the described embodiments.

Standoff with Optimized Drive Feature and Controlled Electrical Contact Surfaces

Current production ‘super-screw’ fasteners function both as indexing fasteners and internally threaded standoffs. These parts have drive features that compromise a portion of the internal threads located on the top of the part. This compromised section is un-useable, growing the size of the super-screw and the parts that interface with it.

An improved design of this style of fastener has been created that includes, (1) controlled surface finishes on the upper and lower sections of the head to ensure optimal electrical contact between the fastener and mating components, and (2) a concave angle on the lower surface of the head, controlling the exact location of electrical contact between the fastener and mating components.

This design implements, in one embodiment, hexagonal drive geometry, but other geometries may be used, including ones that would be keyed, or “tamper resistant”. By eliminating the compromised threads, the fastener may accept shorter screws and/or be decreased in height for a given implementation. This in turn facilitates greater flexibility in assembly height and mating fastener selection. Additionally, the geometry is well suited for production methods that are more economical than parts currently in use.

### Integrated Snap Retention Features

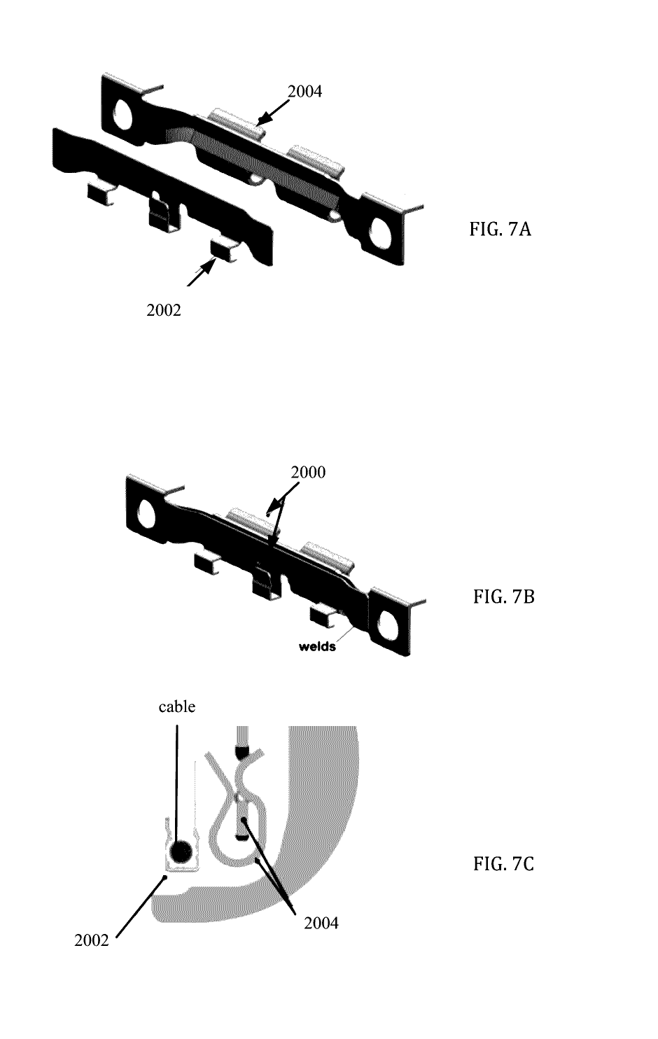

FIGS. 7A-7C show integrated snap feature system 2000 in accordance with an embodiment. In order to take advantage of unutilized or underutilized (sometimes referred to as dead space) around components, retention snaps that would normally be required for clearance to surrounding components to integrate additional retention features for subassembly components. Accordingly, FIG. 7A shows integrated snap retention feature system 2000 where component parts, system component hooks 2002 and component snap 2004 prior to being assembled forming the integrated system. FIG. 7B shows component hooks 2002 and component snap 2004 assembled together using, for example, a welding operation forming the integrated snap feature system 2000. FIG. 7C shows integrate snap feature system 2000 in a use scenario where snap component 2004 is secured to a component and component hooks 2002 carries a cable.

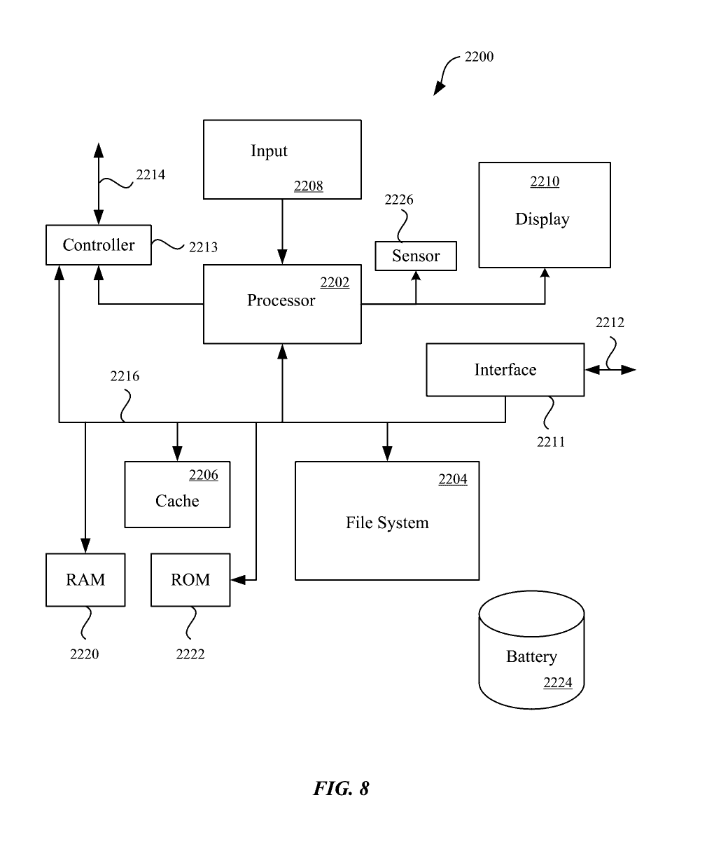

FIG. 8 is a block diagram of an electronic device 2200 suitable for controlling some of the processes in the described embodiment. Electronic device 2200 can illustrate circuitry of a representative computing device. Electronic device 2200 can include a processor 2202 that pertains to a microprocessor or controller for controlling the overall operation of electronic device 2200. Electronic device 2200 can include instruction data pertaining to operating instructions in a file system 2204 and a cache 2206. File system 2204 can be a storage disk or a plurality of disks. In some embodiments, file system 2204 can be flash memory, semiconductor (solid state) memory or the like. The file system 2204 can typically provide high capacity storage capability for the electronic device 2200. However, since the access time to the file system 2204 can be relatively slow, the electronic device 2200 can also include cache 2206. The cache 2206 can include, for example, Random-Access Memory (RAM) provided by semiconductor memory. The relative access time to the cache 2206 can substantially shorter than for the file system 2204. However, cache 2206 may not have the large storage capacity of file system 2204. Further, file system 2204, when active, can consume more power than cache 2206. Power consumption often can be a concern when the electronic device 2200 is a portable device that is powered by battery 2224. The electronic device 2200 can also include a RAM 2220 and a Read-Only Memory (ROM) 2222. The ROM 2222 can store programs, utilities or processes to be executed in a non-volatile manner. The RAM 2220 can provide volatile data storage, such as for cache 2206.

Electronic device 2200 can also include user input device 2208 that allows a user of the electronic device 2200 to interact with the electronic device 2200. For example, user input device 2208 can take a variety of forms, such as a button, keypad, dial, touch screen, audio input interface, visual/image capture input interface, input in the form of sensor data, etc. Still further, electronic device 2200 can include a display 2210 (screen display) that can be controlled by processor 2202 to display information to the user. Data bus 2216 can facilitate data transfer between at least file system 2204, cache 2206, processor 2202, and controller 2213. Controller 2213 can be used to interface with and control different sensors and electrical components with equipment control bus 2214. For example, control bus 2214 can be used to control a display of data on a display in addition to audio and/or video output. For example, processor 2202, upon a certain event occurring, can supply instructions to control another component through controller 2213 and control bus 2214. Such instructions can be stored in file system 2204, RAM 2220, ROM 2222 or cache 2206.

Electronic device 2200 can also include a network/bus interface 2211 that couples to data link 2212. Data link 2212 can allow electronic device 2200 to couple to a host computer or to accessory devices. The data link 2212 can be provided over a wired connection or a wireless connection. In the case of a wireless connection, network/bus interface 2211 can include a wireless transceiver. Sensor 2226 can take the form of circuitry for detecting any number of stimuli. For example, sensor 2226 can take the form of the crack detection sensor described herein and can provide periodic reports to processor 2202, which can be used to adjust overall performance of device 2200 in response to a determination that a display cover of display 2210 has cracked or fractured. In some embodiments, processor 2202 is configured to instruct sensor 2226, which can include a number of different crack detection sensors to provide further characterization of a detected crack by using different sensors to characterize it.

The various aspects, embodiments, implementations or features of the described embodiments can be used separately or in any combination. Software, hardware or a combination of hardware and software can implement various aspects of the described embodiments. The described embodiments can also be embodied as computer readable code on a computer readable medium for controlling manufacturing operations or as computer readable code on a computer readable medium for controlling a manufacturing line. The computer readable medium is any data storage device that can store data, which can thereafter be read by a computer system. Examples of the computer readable medium include read-only memory, random-access memory, CD-ROMs, HDDs, DVDs, magnetic tape, optical data storage devices, semi-conductor memory and cloud-based memory. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A portable electronic device, comprising:
a device housing comprising walls that define a cavity, the walls having edges that define an opening that leads into the cavity;
operational component assembly features used to secure operational components received through the opening to each other and/or to the walls during an assembly operation; and
a protective cover formed of transparent material and disposed within the opening and secured to the housing at the edges of the walls.

2.-20. (canceled)

21. The portable electronic device as recited in claim 1, wherein the operational components comprise a flexible circuit comprising a flexible loop portion arranged in a spiral formation arranged to accommodate movement of the flexible circuit with respect to an anchor point.

22. The portable electronic device as recited in claim 2, wherein the spiral shape of flexible loop portion to stretch or compress with respect to the anchor point without incurring any damage.

23. The portable electronic device as recited in claim 1, the operational component assembly features comprising a clip structure comprising a metal part insert molded on a plastic portion where surfaces of the metal part that are on opposite sides of the plastic portion are exposed.

24. The portable electronic device as recited in claim 4, wherein the clip structure is characterized as having an open ended shape.

25. The portable electronic device as recited in claim 5, wherein the open ended shape comprises a C shape.

26. The portable electronic device as recited in claim 1, the operational component assembly features comprising a curved grounding spring arranged to electrically couple conductive surfaces across a gap.

27. The portable electronic device as recited in claim 1, further comprising an integrated snap retention feature system comprising a component hook and a component snap, wherein the component hook secures a cable and the component snap secures the component hook to a component.

28. The portable electronic device as recited in claim 1, the operational component assembly further comprises a self-aligning fastener, the self-aligning fastener comprising a head comprising a controlled surface finish on an upper and lower sections of the head to ensure optimal electrical contact between the fastener and mating components, and a concave angle on a lower surface of the head for controlling the exact location of electrical contact between the fastener and mating components.

29. The portable electronic device as recited in claim 9, the head comprising a hexagonal drive geometry.

30. A curved contact spring for bridging a gap between two separate parts of an electrical assembly, the curved contact spring comprising:
a solid sheet of conductive material having a curved geometry and having a fixed end affixed to a first side of the gap and wherein the curved geometry causes a free end the solid sheet of conductive material to curve towards and to contact a second side of the gap.

31. The curved contact spring as recited in claim 11, wherein the curved geometry is characterized as a gradual curve having a large radius or curvature.

32. The curved contact spring as recited in claim 12, where the curved geometry is a spline shape.

33. The curved contact spring as recited in claim 11, wherein a minimum gap distance corresponds to a material thickness of the conductive sheet.

34. A retention strap capable of retaining a circuit module, the retention strap comprising:
a body having a size and shape corresponding to the circuit module;
a fastener arranged to secure the body to a printed circuit board, wherein the body maintains a relative position of the circuit module with respect to an other component mounted to the printed circuit board.

35. The retention strap as recited in claim 15, further comprising:
An extended flex connector that electrically connects the circuit module the other component mounted to the printed circuit board.

36. The retention strap as recited in claim 15, wherein the retention strap is used to decouple the extended flex connector that couples the circuit module to the other electronic component such that any relative movement between the circuit module and the other electronic component.

37. The retention strap as recited in claim 17, wherein the retention strap prevents change in the electrical properties of the electrical connection between the flex connector and the circuit module and other component.

38. The retention strap as recited in claim 17, wherein a length of the extended flex connector prevents change in the electrical properties of the electrical connection between the flex connector and the circuit module and other component.

39. The retention strap as recited in claim 15, wherein the circuit module is disposed within a portable electronic device.
